(19) United States
(12) Patent Application Publication
(10) Pub. No.: US 2014/0088782 A1
(43) Pub. Date: Mar. 27, 2014

(54) ENERGY-SAVING APPARATUS AND ENERGY-SAVING SYSTEM

(71) Applicant: UBITEQ, INC., Tokyo (JP)

(72) Inventor: Tsukasa OGINO, Tokyo (JP)

(73) Assignee: UBITEQ, INC., Tokyo (JP)

(21) Appl. No.: 14/093,342

(22) Filed: Nov. 29, 2013

Related U.S. Application Data
(63) Continuation of application No. PCT/JP2012/063582, filed on May 28, 2012.

(30) Foreign Application Priority Data
May 30, 2011 (JP) 2011-120338
Sep. 14, 2011 (JP) 2011-201189
Sep. 14, 2011 (JP) 2011-201190
Sep. 14, 2011 (JP) 2011-201191

(51) Int. Cl. H02J 4/00

(52) U.S. Cl. CPC H02J 4/00
USPC 700/295

(57) ABSTRACT

The present disclosure provides an energy-saving apparatus that can switch a plurality of templates containing procedures for controlling the connected devices. The energy-saving apparatus comprises a template storing section that stores a plurality of templates containing procedures for controlling the connected device; an operation controlling section that selects a template to be executed that is used for controlling the operation of the connected device from among a plurality of the templates and controls the operation of the connected device according to the template to be executed; and a discomfort index calculating section that calculates a discomfort index showing a discomfort level of a user of the connected device corresponding to the template to be executed based on an amount of change of a setting of the connected device and that stores the discomfort index in association with the template to be executed; wherein the operation controlling section reselects the template to be executed based on the discomfort index.

### CROSS REFERENCE TO RELATED APPLICATIONS

The present application is a continuation application of International Application number PCT/JP2012/063582, filed on May 28, 2012, which claims priority to Japanese Patent Applications number 2011-120338, filed on May 30, 2011, number 2011-201189, filed on Sep. 14, 2011, number 2011-201190, filed on Sep. 14, 2011, and number 2011-201191, filed on Sep. 14, 2011. The contents of these applications are incorporated herein by reference in their entirety.

### TECHNICAL FIELD

This disclosure relates to an energy-saving apparatus and an energy-saving system.

### DESCRIPTION OF THE RELATED ART

In most modern buildings, a BAS (Building Automation System) or a BEMS (Building Energy Management System), which controls the operation of connected devices such as an air conditioning device or a lighting device in a building, is implemented. The Japanese unexamined patent publication number 2006-318234 and the Japanese unexamined patent publication number H03-244952 disclose a system that maintains a room temperature uniformly at a configured value by controlling the operation of the connected devices in the building. The Japanese unexamined patent publication number 2004-170310 and the Japanese unexamined patent publication number 2005-261050 disclose a system that controls connected devices to reduce energy consumption in accordance with a target value of energy consumption of connected devices in a building. Further, the Japanese unexamined patent publication number 2008-128526 discloses a system where target values for operating the connected devices are set based on an environmental requirement inputted by a user.

However, in the existing systems, it was difficult to reduce the amount of energy consumption while maintaining a comfortable room temperature because operation patterns of connected devices were not able to be controlled although connected devices were able to be controlled in response to the room temperature or the amount of energy consumption. For example, when a room temperature rises, the room temperature could be decreased by lowering the target temperature of the air conditioning equipment. However, changing the target temperature of the air conditioning equipment would increase the amount of energy consumption.

It was also difficult to reduce the amount of energy consumption without affecting user comfort. Specifically, a dedicated terminal for a user to input whether or not the user feels comfortable was required in order to control the connected devices in accordance with whether or not the user feels comfortable, and there were the problems that the cost of the system would increase and input operations by the user would be required.

### SUMMARY

To solve the above-mentioned problems, according to the first aspect of the present disclosure, the present disclosure provides an energy-saving apparatus that can switch a plurality of templates containing procedures for controlling the connected devices. Specifically, the present disclosure provides an energy-saving apparatus for controlling energy consumption of a connected device in a building. The energy-saving apparatus comprises a template storing section that stores a plurality of templates containing procedures for controlling the connected device; an operation controlling section that selects a template to be executed that is used for controlling the operation of the connected device from among a plurality of the templates and controls the operation of the connected device according to the template to be executed; and a discomfort index calculating section that calculates a discomfort index showing a discomfort level of a user of the connected device corresponding to the template to be executed based on an amount of change of a setting of the connected device and that stores the discomfort index in association with the template to be executed; wherein the operation controlling section reselects the template to be executed based on the discomfort index.

According to the second aspect of the present disclosure, the present disclosure provides an energy-saving apparatus for controlling energy consumption of a connected device in each of a plurality of compartments in a building. The energy-saving apparatus comprises a template storing section that stores a plurality of templates containing procedures for controlling the connected device in each compartment; a reserved time storing section that stores reserved times of each of the compartments; and an operation controlling section that selects a template to be executed that is used for controlling the operation of the connected device from among a plurality of the templates based on the reserved times and controls the operation of the connected device in each of the compartments; wherein the operation controlling section selects a first template to be executed when the compartment is not reserved, and selects a second template that is different from the first template when the compartment is reserved.

According to the third aspect of the present disclosure, the present disclosure provides a method for controlling a connected device in a building. The method comprises selecting a template to be executed that is used for controlling the operation of the connected device from among a plurality of the templates containing procedures for controlling the connected device; controlling the operation of the connected device according to the template to be executed; and calculating a discomfort index showing a discomfort level of a user of the connected device corresponding to the template to be executed based on an amount of change of a setting of the connected device; storing the discomfort index in association with the template to be executed; and reselecting the template to be executed based on the discomfort index.

According to the fourth aspect of the present disclosure, the present disclosure provides a method for controlling a connected device in each of a plurality of compartments in a building. The method comprises storing reserved times of each of the compartments; selecting a template to be executed that is used for controlling the operation of the connected device from among a plurality of the templates, wherein a first template to be executed is selected when the compartment is not reserved, and a second template that is different from the first template is selected when the compartment is reserved; and controlling the operation of the connected device according to the selected template to be executed.

According to the fifth aspect of the present disclosure, the present disclosure provides an energy-saving system for controlling energy consumption of a connected device in a building. The energy-saving system comprises a device controlling terminal that controls the connected device; and a server that stores a plurality of templates containing procedures for making the device controlling terminal control the connected device. The server includes a template storing section that stores a plurality of templates containing procedures for controlling the connected device; an operation controlling section that selects a template to be executed that is used for controlling the operation of the connected device from among a plurality of the templates and make the device controlling terminal control the operation of the connected device according to the template to be executed; and a discomfort index calculating section that calculates a discomfort index showing a discomfort level of a user of the connected device corresponding to the template to be executed based on an amount of change of a setting of the connected device and that stores the discomfort index in association with the template to be executed; wherein the operation controlling section reselects the template to be executed based on the discomfort index.

According to the sixth aspect of the present disclosure, the present disclosure provides an energy-saving system for controlling energy consumption of a connected device in each of a plurality of compartments in a building. The energy-saving system comprises a device controlling terminal that controls the connected device in each of the compartments; and a server that stores a plurality of templates containing procedures for making the device controlling terminal control the connected device. The device controlling terminal controls the connected device in each of the compartments according to the template to be executed selected from among the plurality of templates by the server based on the reserved time of the compartment. The server selects a first template to be executed when the compartment is not reserved, and selects a second template that is different from the first template when the compartment is reserved.

The summary of the disclosure does not include all the features required for the present disclosure. The present disclosure may also be a sub-combination of the features described above.

### BRIEF DESCRIPTION OF THE DRAWINGS

FIG. 1 shows an exemplary configuration of an energy-saving apparatus and an energy-saving system in the first embodiment.

FIG. 2 shows an exemplary configuration in a compartment in the first embodiment.

FIG. 3A shows an example of a plurality of templates to be selected according to a reserved time of each compartment.

FIG. 3B shows an example of a plurality of templates to be selected according to a reserved time of each compartment.

FIG. 4 shows an exemplary configuration of the energy-saving apparatus and the energy-saving system according to another embodiment.

FIG. 5 shows an exemplary configuration of the energy-saving apparatus and the energy-saving system according to another embodiment.

FIG. 6 shows an exemplary configuration of the energy-saving apparatus and the energy-saving system according to another embodiment.

FIG. 7 shows an exemplary configuration of the energy-saving apparatus and the energy-saving system according to another embodiment.

FIG. 8 shows an exemplary configuration of the energy-saving apparatus and the energy-saving system according to another embodiment.

FIG. 9 shows an exemplary configuration of the energy-saving apparatus and the energy-saving system according to another embodiment.

FIG. 10 shows an exemplary configuration of the energy-saving apparatus and the energy-saving system according to another embodiment.

FIG. 11 shows an exemplary configuration of the energy-saving apparatus according to another embodiment.

FIG. 12 shows an exemplary configuration of the energy-saving apparatus and the energy-saving system according to another embodiment.

FIG. 13 shows an exemplary hardware configuration of a computer that composes the energy-saving apparatus according to another embodiment.

FIG. 14 shows an example of a flowchart when the CPU executes the energy-saving program according to the present embodiment.

### DESCRIPTION OF EXEMPLARY EMBODIMENTS

Hereinafter, the present invention will be described through embodiments of the present invention. The following embodiments do not limit the claimed inventions, and all of the combinations of the features that are described in the embodiment are not always essential for the means for solving the problems of the invention.

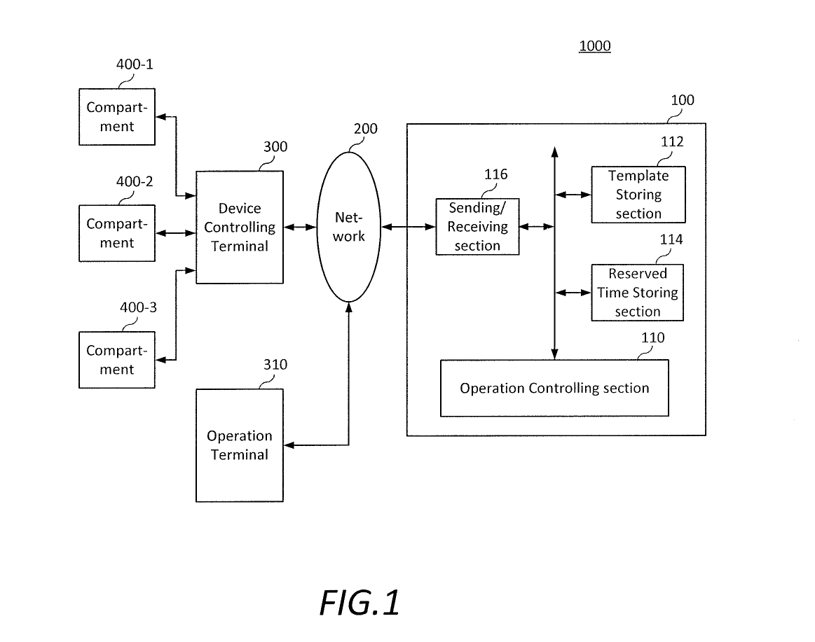

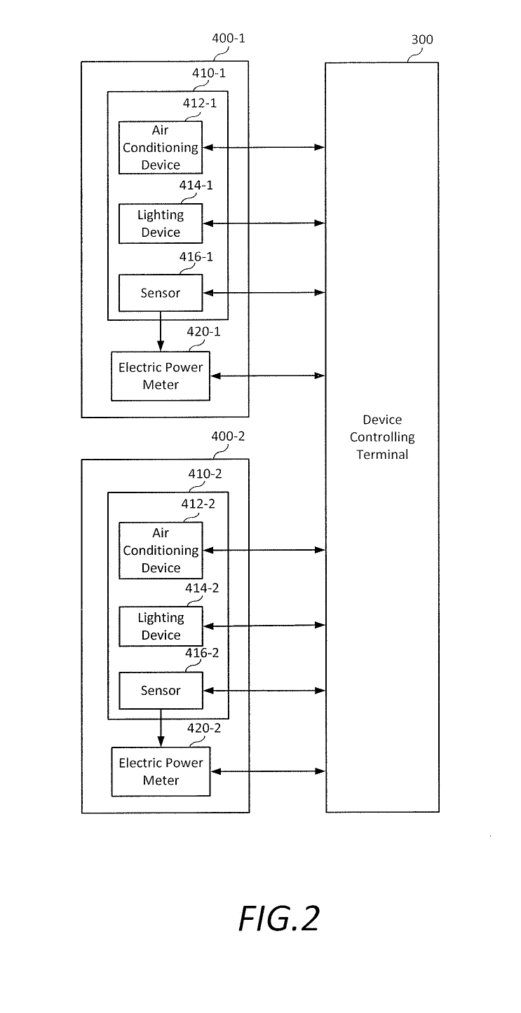

FIG. 1 shows an exemplary configuration of an energy-saving apparatus 100 and an energy-saving system 1000 according to one of the embodiments in the present disclosure. FIG. 2 shows an exemplary configuration in a compartment 400 according to one of the embodiments in the present disclosure.

The energy-saving system 1000 comprises an energy-saving apparatus 100 and a device controlling terminal 300. The energy-saving apparatus 100 controls connected devices 410 in a compartment 400 via a network 200 and the device controlling terminal 300. The energy-saving apparatus 100 may control the connected devices 400 in the compartment 400 without using the device controlling terminal 300. The network 200 is a communication network for sending/receiving data, for example, the internet.

As shown in FIG. 2, the compartment 400 has a plurality of the connected devices 410. Each connected device 410 is a device that is connected to an energy-supply system of the building. For example, the connected devices 410 may be an air conditioning device 412, a lighting device 414, and a sensor 416, which are connected to an electrical system. The connected device 410 may be a computer device or a network device. The connected devices 410 may also be devices that are connected to a gas supply system.

The compartment 400 may have an electric power meter 420 that measures electric power consumption of the connected devices 410. The electric power meter 420 measures the electric power that is consumed by each of the air conditioning device 412, the lighting device 414, and the sensor 416, and sends the total sum of the measured powers to the energy-saving apparatus 100 via the device controlling terminal 300. The electric power meter 420 may send the values of the electric power consumed by each of the air conditioning device 412, the lighting device 414, and the sensor 416 to the energy-saving apparatus 100.

The device controlling terminal 300 is connected to the connected devices 410 in the compartment 400. The device controlling terminal 300 may be connected to the connected devices 410 through a wired communication line or a wireless communication line. The device controlling terminal 300 sends and receives data to and from the connected devices 410 through the wired communication line or the wireless communication line. For example, the device controlling terminal 300 sends the data for controlling the connected devices 410 to the connected devices 410 based on the data received from the energy-saving apparatus 100. The device controlling terminal 300 may receive the data showing the status of the connected devices 410 from the connected devices 410s, and may send this data to the energy-saving apparatus 100.

The energy-saving system 1000 may comprise an operation terminal 310. The operation terminal 310 registers setting data to the energy-saving system 100 by sending and receiving data to and from the energy-saving apparatus 100 through the network 200. The operation terminal 310 may send reservation information including a reserved time of the compartment 400 to the energy-saving apparatus 100. The operation terminal 310 comprises an operation section for inputting data, and a display section for displaying data. The operation terminal 310 is, for example, a personal computer.

The energy-saving apparatus 100 controls energy consumption of the connected devices 410 that are set in each of a plurality of the compartments 400 (compartment 400-1, compartment 400-2, and compartment 400-3) inside the building. Each compartment 400 is an area that is surrounded by walls or partitions that cut off air convection. The compartments 400 are, for example, a working room, a meeting room, a reception room, and an entrance hall.

The energy-saving apparatus 100 may control an arbitrary number of the compartments 400. For example, the energy-saving apparatus 100 may control one compartment 400 or k compartments 400. In this regard, k is an integer that is greater than or equal to two.

The energy-saving apparatus 100 has an operation controlling section 110, a template storing section 112, a reserved time storing section 114, and a sending/receiving section 116. The template storing section 112 stores a plurality of templates containing procedures for controlling the connected device 410 in each compartment 400. For example, the template is a program that defines timings for starting the operation of the connected devices 410, timings for stopping the operation of the connected devices 410, and operating modes of the connected devices 410. The template may be a group of numerical values that defines timings for starting the operation of the connected devices 410, timings for stopping the operation of the connected devices 410, and operating modes of the connected devices 410.

The template storing section 112, for example, stores templates containing procedures for controlling a plurality of the connected devices 410 in each of the compartments 400. The template storing section 112 may store the templates containing procedures of controlling the connected devices 410 in each compartment 400 in association with each compartment 400.

The template storing section 112 may store a plurality of different templates for controlling the connected devices 410 with different patterns according to the types of the compartments 400. In one instance, the template storing section 112 stores a template for turning on all lighting devices 414 in the compartment 400-1 and for turning on half of the lighting devices 414 in the compartment 400-2. The template storing section 112 may store a template for continuously operating the air conditioning device 412 in the compartment 400-1 and intermittently operating the air conditioning device 412 in the compartment 400-2.

The template storing section 112 may store a plurality of templates for operating the connected devices 410 in a plurality of the compartments 400 in different modes. For example, the template storing section 112 stores the template for using a “hard energy-saving mode” that increases the power saving amount by intermittently operating a cooling function of the air conditioning device 412 and by decreasing luminance of the lighting device 414 in the compartment 400-1, and for using a “soft energy-saving mode” in which power the saving amount is smaller than that of “hard energy-saving mode” by continuously operating the cooling function of the air conditioning device 412 in the compartment 400-2. This template is suitable for the case when the compartment 400-1 is used by only employees, and the compartment 400-2 is used by both the employees and visitors.

The template storing section 112 may store a plurality of different templates that control the connected devices 410 by different patterns according to a business category, a business aspect, or a working style of the people who use the compartments 400. For example, the template storing section 112 stores (i) a template for a computer room that has a controlling pattern for prioritizing temperature more than luminance, (ii) a template for an office that has a controlling pattern for prioritizing the luminance more than the temperature, and (iii) a template for a shop that prioritizes the balance of the temperature and the luminance.

The template storing section 112 may store different types of the templates for each season. For example, the template storing section 112 stores a template for summer that uses a cooling function of the air conditioning device 412 and a template for winter that uses a heating function of the air conditioning device 412.

The reserved time storing section 114 stores a reserved time of each compartment 400. The reserved time storing section 114 stores a scheduled time for starting use of the compartment 400 and a scheduled time for finishing use of the compartment 400, in association with each of the compartments 400. The operation controlling section 110 selects a template to be executed that is used for controlling the operation of the connected devices 410 from among a plurality of the templates. The operation controlling section 110 controls the operation of the connected devices 410 for each compartment 400 according to the template to be executed.

The operation controlling section 110 may reselect the template to be executed according to at least one of the variations of the status of the connected devices 410 and variations of the status of the compartment 400 in which the connected devices 410 are installed. For example, the operation controlling section 110 selects a template to be executed for controlling the operation of the connected devices 410 from among a plurality of the templates based on the reserved time.

For example, the operation controlling section 110 changes the template to be executed at each scheduled time for starting use of the compartment 400 and each scheduled time for finishing use of the compartment 400. The operation controlling section 110 may change a template to be executed at a predetermined time earlier or later than the scheduled time. In one instance, the operation controlling section 110 changes a template such that this template is executed earlier than the scheduled time for starting use of the compartment 400, by the amount of time needed for the room temperature of the compartment 400 to become settled by the operation of the connected device 410.

The reserved time storing section 114 may store use information that shows a type of use of each compartment 400. For example, the reserved time storing section 114 stores use information that shows whether the compartment 400 is a reception room that is used for a meeting with visitors or a meeting room that is used for a meeting without visitors in association with the reserved time. The operation controlling section 110 may control the operation of the connected devices 410 in the compartment 400 by using the template to be executed that is selected based on the reserved time and the use information.

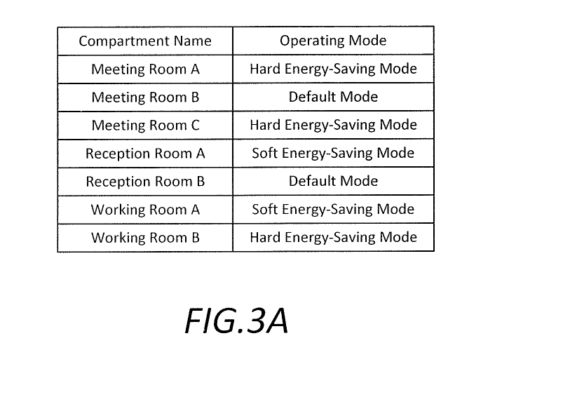

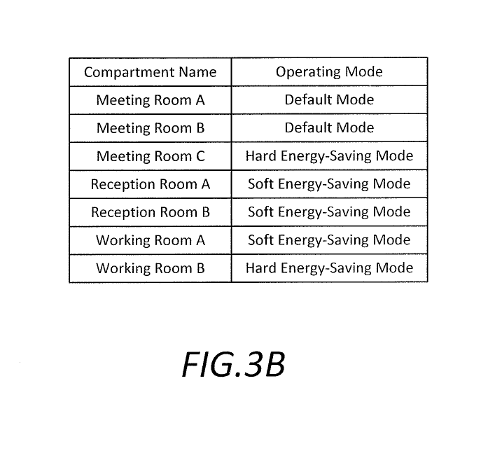

FIGS. 3A and 3B show examples of a plurality of the templates that are selected according to the reserved time of each compartment 400. FIG. 3A shows an example of a template that the operation controlling section 110 selects when the meeting room A, the meeting room C, and the reception room A are reserved. FIG. 3B shows an example of a template that the operation controlling section 110 selects when the meeting room C, the reception room A, and the reception room B are reserved.

When the meeting room B and the reception room B are not reserved, the operation controlling section 110 operates the connected devices 410 in the meeting room B and the reception room B in a “default mode.” In the “default mode,” the operation controlling section 110, for example, stops operating the air conditioning device 412 and the lighting device 414.

When the meeting room A and the meeting room C are reserved, the operation controlling section 110 operates the connected devices 410 in the meeting room A and the meeting room C in the “hard energy-saving mode.” When the reception room A is reserved, the operation controlling section 110 operates the connected device 410 in the reception room A in the “soft energy-saving mode,” in which energy consumption and the ability of cooling or warming is larger than that of the “hard energy-saving mode.”

As seen above, the operation controlling section 110 controls the connected devices 410 in each compartment 400 by using the templates shown in FIGS. 3A and 3B, which are selected according to the reserved time of the compartment 400. Thus, since the energy consumption in each compartment 400 can be controlled according to the status of reservations of the meeting room, etc., the energy consumption of the whole building can be suppressed, while the comfort in the used compartments 400 can be maintained.

The operation controlling section 110 further controls the connected devices 410 in each compartment 400 by using the selected template according to the type of use of the compartment 400. Therefore, the energy consumption in the whole building can be suppressed, while maintaining the reception room A where meetings with visitors are held at a more comfortable state than the meeting rooms A and C where meetings without visitors are held.

The operation controlling section 110 may select a template based on the state of reservations of the compartments 400. For example, the meeting room B is assumed to be reserved for a meeting with a visitor from 10 am to 11 am.

The operation controlling section 110 operates the meeting room A in the “hard energy-saving mode” and operates the meeting room B in the “soft energy-saving mode” from 10 am to 11 am. As mentioned above, by selecting the appropriate template according to the reserved time and the type of use, the operation controlling section 110 can operate in the operating mode suitable for the use, to reduce the energy consumption.

The reserved time storing section 114 may further store a reserved time of a plurality of the connected devices in each compartment 400. The person who reserved the compartment 400 can reserve the connected devices which are planned to be used during the reserved time of the compartment 400. For example, when the first lighting device, the second lighting device, the first air conditioning device, the second air conditioning device, the first computer, the second computer, the first projector, and the second projector are in the compartment 400, only the first lighting device, the first air conditioning device, the first computer, and the first projector are reserved for a meeting in which the number of attendees is less than the capacity of the compartment 400. When the user uses the compartment 400 for a meeting in which the number of attendees is almost the same as the capacity of the compartment 400, all the connected devices are reserved.

The template storing section 112 may store a plurality of the templates that correspond to the content of reservations of the connected devices in the compartment 400. At the reserved time of the connected devices in the compartment 400, the operation controlling section 110 changes the template according to the content of the reservation of the connected devices.

For example, when a computer and a projector that emits a large amount of heat are reserved together with an air conditioning device, the operation controlling section 110 selects a template of an operation mode for increasing the cooling capacity of the air conditioning device because the possibility that the temperature will increase is high. The operation controlling section 110 may select the template according to the electric power consumption of the reserved connected devices. For example, when the computer that consumes more electric power is reserved, the operation controlling section 110 decreases the cooling capacity of the air conditioning device so that the electric power consumption in the compartment 400 is reduced.

As mentioned above, by selecting the template to be executed according to the status of the reservation of the connected devices in the compartment 400, the operation controlling section 110 can provide appropriate environments according to the use status of the connected devices, and can also save energy.

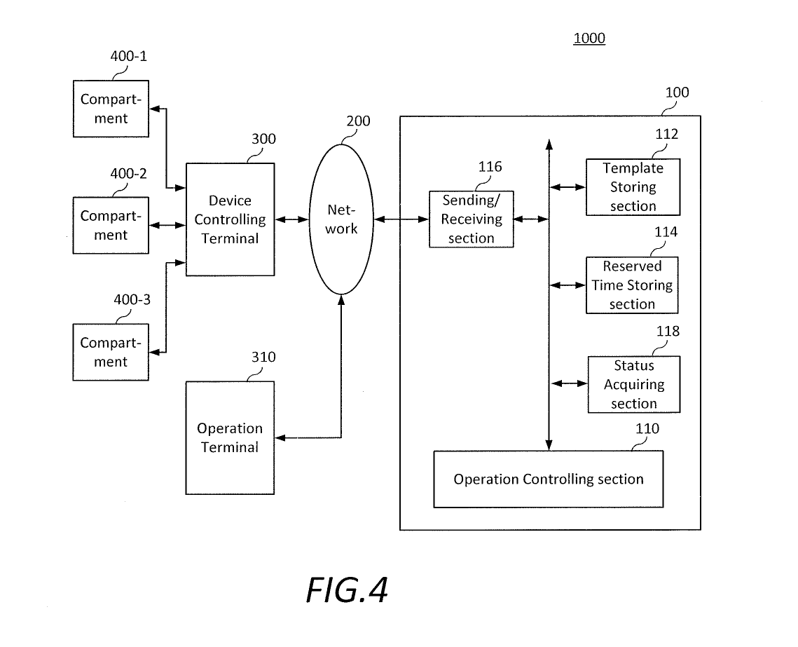

FIG. 4 shows an exemplary configuration of the energy-saving apparatus 100 and the energy-saving system 1000 in another embodiment. The energy-saving apparatus 100 as shown in FIG. 4 further comprises a status acquiring section 118, as compared to the energy-saving apparatus 100 as shown in FIG. 1. The status acquiring section 118 acquires a compartment status signal that shows a status of each compartment 400 from the device controlling terminal 300 to which the connected devices 410 are connected. For example, the status acquiring section 118 acquires any of (i) a presence status signal that shows a presence of a person in the compartment 400, (ii) a temperature information signal that shows temperature in the compartment 400, and (iii) an luminance signal that shows luminance in the compartment 400 from a sensor 416 that is set in the compartment 400 through the device controlling terminal 300. The sensor 416 is, for example, a motion sensor, a temperature sensor, and/or a luminance sensor.

The operation controlling section 110 may select the template to be executed according to the reserved time and the compartment status signal, and may make the device controlling terminal 300 control the operation of the connected devices 410. The operation controlling section 110 may reselect the template to be executed according to changes of at least one of the presence status signal, the temperature information signal, and the luminance signal.

For example, when the compartment status signal shows that no one is present during the time when the compartment 400 is reserved, the operation controlling section 110 reselects the template that corresponds to the operational mode that reduces the energy consumption in the compartment 400. When no one is present in the compartment 400 during the time when the compartment 400 is reserved, the operation controlling section 110 may operate in a mode in which the energy consumption is larger than that of the operational mode in the time when the compartment 400 is not reserved. Owing to such operations of the operation controlling section 110, a rapid variation in room temperature can be prevented when a person temporarily becomes absent from the compartment 400.

When the status acquiring section 118 acquires a presence status signal that shows whether or not a person exists in the compartment 400, and when the presence status signal remains unchanged after a predetermined time passes from the reservation starting time, the operation controlling section 110 may make the device controlling terminal 300 stop the operation of the connected device 410, and may send an e-mail to a predetermined address. For example, the operation controlling section 110 sends an e-mail to the address of a person who reserved the compartment 400. The operation controlling section 110 may send an e-mail to the address of an administrator of the compartment 400.

The operation controlling section 110 may reselect the template to be executed based on the contents of the reply e-mail in response to the e-mail sent by the operation controlling section 110. For example, when the reply e-mail shows that the reservation of the compartment 400 is canceled, the operation controlling section 110 changes the template to a template that can reduce the energy consumption in the compartment 400.

The operation controlling section 110 may reduce the energy consumption in the compartment 400 by reselecting the template to be executed after a predetermined time passes from sending the e-mail. By controlling the operation of the connected devices 410 in this manner by the operation controlling section 110, the appropriate environment of the compartment 400 can be maintained without immediately stopping the connected devices 410 when the start of using the compartment 400 is merely delayed, and also consuming wasteful energy can be prevented when the use of the compartment 400 is cancelled.

The operation controlling section 110 may send an e-mail to the predetermined address in response to the variation of the presence status signal. When a person coming into the compartment 400 is detected by a variation of the presence status signal, the operation controlling section 110 may acquire the reservation information of the compartment 400 from the reserved time storing section 114. If a person is detected when the compartment 400 is not reserved, the operation controlling section 110 may send an e-mail to a predetermined address. For example, the operation controlling section 110 sends an e-mail to the administrator of the compartment 400.

When a predetermined time has passed after the variation of the presence status signal, the operation controlling section 110 may select a template that is used when a person is detected in a non-reserved compartment 400. For example, when the compartment 400 has a high airtightness, staying in the compartment 400 for many hours without using the air conditioning device may be harmful to health. Therefore, the operation controlling section 110 may select a template in which energy consumption is lower than in the template that is selected when a person exists in a reserved compartment, a predetermined time after the variation of the presence status signal that shows the existence of a person in the non-reserved compartment 400.

When a predetermined time has passed after a person is detected in the non-reserved compartment, the operation controlling section 110 may send an e-mail, and may select a template in which energy consumption is smaller than in the template that is selected when a person is detected in a reserved compartment if a person is still detected after a predetermined time has passed from sending the e-mail. The operation controlling section 110 may cancel the operation based on the template when no person comes to be detected. Owing to the control of the operation controlling section 110 as mentioned above, the time for an administrator of the compartment 400 to confirm the status of the compartment 400 or to determine whether or not operating the air conditioning device is allowed can be secured.

The operation controlling section 110 starts operating the connected device 410 in the compartment 400 prior to the reserved time of the compartment 400 according to the template to be executed. For example, the operation controlling section 110 may make the compartment 400 comfortable by starting the operation of the air conditioning device 412 at ten minutes before the reservation starting time of the compartment 400.

The operation controlling section 110 may start operating the connected devices 410 earlier than the reservation starting time based on the time that corresponds to the type of use of the compartment 400. For example, the operation controlling section 110 may start operating the air conditioning device 412 ten minutes before the reservation starting time in the compartment 400-1 that is used for a meeting with a visitor, and may start operating the air conditioning device 412 at the reservation starting time in the compartment 400-2 that is used for a meeting without a visitor. Owing to such controls by the operation controlling section 110, the energy consumption can be reduced while an appropriate environment for the compartment 400 is provided according to the type of use and the reserved time of the compartment 400.

The operation controlling section 110 may control each of the connected devices 410 at different timings. In one instance, the operation controlling section 110 starts operating the air conditioning device 412 before the reserved time of the compartment 400, and starts operating the lighting device 414 after starting operation of the air conditioning device 412. Specifically, the operation controlling section 110 may start operating the air conditioning device 412, which requires a longer time before an effect appears after the operation starts, ten minutes before the reservation starting time, and may start operating the lighting device 414, which requires a shorter time before an effect appears after the operation starts, at the reservation starting time. The operation controlling section 110 may start operating the lighting device 414 when a person who entered the compartment 400 is detected.

The operation controlling section 110 stops operating the connected device 410 after the end of the reserved time of the compartment 400 according to the template to be executed. The operation controlling section 110 may determine whether or not to stop operating the connected device 410, according to whether or not a person remains in the compartment 400 after the end of the reserved time of the compartment 400.

The operation controlling section 110 may determine whether or not to stop operating the connected device 410, according to the next reserved time of the compartment 400 after the reserved time. For example, when the next reservation exists within the time required for starting up the connected device 410 after the end of the reserved time of the compartment 400, the operation controlling section 110 continues operating the connected device 410.

The operation controlling section 110 may select the template to be executed further according to a temperature at some points in the building that have the compartments 400. For example, when the atmosphere temperature is over 35 degrees Celsius, the operation controlling section 110 selects a template that corresponds to a larger cooling capacity than when the atmosphere temperature is less than or equal to 35 degrees Celsius.

The operation controlling section 110 may change the timing of reselecting the template to be executed further according to the temperature at some points in the building that have the compartments 400. For example, when the atmosphere temperature is over 35 degrees Celsius, the operation controlling section 110 reselects the template to be executed earlier than when the atmosphere temperature is less than or equal to 35 degrees Celsius. Specifically, when the temperature is higher than a predetermined temperature, the operation controlling section 110 starts operating the air conditioning device 412 earlier than the reservation starting time.

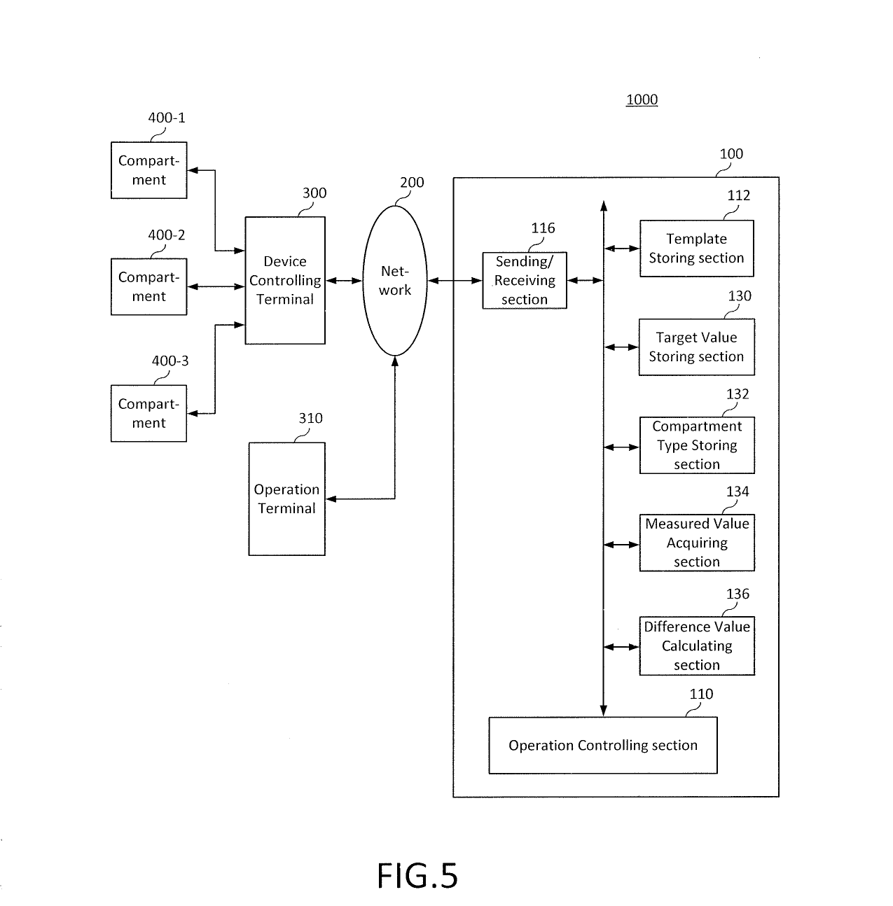

FIG. 5 shows an exemplary configuration of the energy-saving apparatus 100 and energy-saving system 1000 according to another embodiment. The energy-saving apparatus 100 shown in FIG. 5 comprises a target value storing section 130, a compartment type storing section 132, a measured value acquiring section 134, and a difference value calculating section 136 in place of the reserved time storing section 114 of the energy-saving apparatus 100 shown in FIG. 1.

The target value storing section 130 stores a target value of the total energy consumption in the plurality of compartments 400. For example, as shown in FIG. 5, when there are a compartment 400-1, a compartment 400-2, and a compartment 400-3 in the building, the target value storing section 130 stores a target value of the total sum of instantaneous power consumption of the connected devices 410 in each compartment 400-1, 400-2, and 400-3.

In one instance, the target value storing section 130 receives and stores the target value of the total energy consumption inputted at the operation terminal 310. The target value storing section 130 may receive the target value that is inputted at the energy-saving apparatus 100. The target value storing section 130 may preliminarily store the target value of the total energy consumption, for example, in association with date and time. The target value storing section 130 may store the target value of the total energy consumption that is received from the energy supplier.

The compartment type storing section 132 stores compartment types of each compartment 400. The compartment type is an element that characterizes the compartment, such as the type of use of the compartment, the area of the compartment, the type of users of the compartment, the location of the compartment, and the operating time of the compartment. In one instance, the compartment type storing section 132 receives and stores the compartment type which is inputted at the operational terminal 310. Specifically, a user of the energy-saving system 1000 inputs the type of use of the compartment in association with each compartment 400 at the operational terminal 310. For example, the operation terminal 310 receives inputs of the compartment types showing that the compartment 400-1 is a meeting room, the compartment 400-2 is a reception room, and the compartment 400-3 is a working room.

The compartment type storing section 132 may store power-saving priority information in association with each compartment 400. For example, when the compartment 400-1 is a meeting room only for employees and the compartment 400-2 is a reception room for visitors, the compartment type storing section 132 stores the power-saving priority information showing a higher priority of the compartment 400-1 than the power-saving priority of the compartment 400-2. Specifically, the compartment type storing section 132 may store the value that corresponds to the first power-saving priority in association with the compartment 400-1, and may store the value that corresponds to the second power-saving priority showing lower priority than the first power-saving priority in association with the compartment 400-2.

The measured value acquiring section 134 acquires the measured value of the total energy consumption in a plurality of the compartments 400. Specifically, the measured value acquiring section 134 acquires the value of energy consumption that was measured by the electric power meter 420 shown in FIG. 2 through the device controlling terminal 300 and the network 200. The measured value acquiring section 134 may acquire the value of energy consumption that was measured by the electric power meter 420 directly from the electric power meter 420.

The device controlling terminal 300 adds together the values of energy consumption that were measured by the electric power meters 420 installed in each compartment 400, and sends the total value to the measured value acquiring section 134. The measured value acquiring section 134 may acquire the measured value of the total energy consumption in a plurality of the compartments 400 by acquiring the energy consumption values that were measured by the electric power meters 420 in the compartments 400 and by adding together the acquired values.

The difference value calculating section 136 calculates a difference value by subtracting the target value stored in the target value storing section 130 from the measured value acquired by the measured value acquiring section 134. For example, when the target value stored in the target value storing section 130 is 10 kW and the measured value is 15 kW, the difference value calculating section 136 calculates the difference value as 5 kW. When the target value stored in the target value storing section 130 is 10 kW and the measured value is 8 kW, the difference value calculating section 136 calculates the difference value as −2 kW.

The operation controlling section 110 selects the template to be executed that is used for the operation control of the connected device 410 from among a plurality of templates, based on the compartment type stored in the compartment type storing section 132 and the difference value calculated by the difference value calculating section 136. The operation controlling section 110 controls the operation of the connected devices 410 in a plurality of the compartments 400 according to the selected template to be executed.

When the difference value is a positive value, the operation controlling section 110 selects the template in which the operation modes for the connected devices 410 in each compartment 400 are different from each other. Specifically, when the difference value is a positive value, the operation controlling section 110 may select the template for operating the compartment 400-1 with a higher power-saving priority in the ‘hard energy-saving mode’ and for operating the compartment 400-2 with a lower power-saving priority than the compartment 400-1 in the ‘soft energy-saving mode,’ in which energy consumption is greater than that of the ‘hard energy-saving mode.’

When the difference value is a negative value, the operation controlling section 110 may select a template in which the same operation modes are applied irrespective of the compartment type. For example, when the difference value is a negative value, the operation controlling section 110 selects the template for operating the compartments 400-1 and 400-2 in the ‘soft energy-saving mode.’

When the difference value is larger than the predetermined first difference value, the operation controlling section 110 may reselect the template to be executed according to the power-saving priority. For example, when the difference value becomes larger than zero by changing from a negative value to a positive value, the operation controlling section 110 changes the template to be executed to the template that reduces the energy consumption of the compartment 400-1 with a higher power-saving priority. When the difference value changes from a positive value to a negative value, the operation controlling section 110 may change the template to be executed to the template that increases the energy consumption of the compartment 400-2 that has a lower power-saving priority.

When the difference value becomes larger than the second difference value, which is larger than the first difference value, the operation controlling section 110 may reselect the template to be executed so that the energy consumption in the second compartment 400 in which power-saving priority is lower than that of the first compartment 400 is reduced. Specifically, the operation controlling section 110 may change the template to be executed to the template that reduces the energy consumption in the compartment 400-2, when the difference value becomes larger than 2 kW after reducing the energy consumption of the compartment 400-1 in which power-saving priority is higher than that of the compartment 400-2 when the difference value becomes larger than zero.

When the difference value becomes larger than a predetermined value, the operation controlling section 110 may reselect the template according to the compartment types of the compartments 400, and the priority of the plurality of the connected devices 410. For example, the operation controlling section 110 determines that the priority of the air conditioning device 412 is higher than that of the lighting device 414 for the compartment 400-1 near windows, and reselects the template to be executed to be an air conditioning prioritized template that reduces the energy consumption of the lighting device 414.

The operation controlling section 110 may reselect the template to be executed according to the amount of energy consumption of the connected device 410. For example, when the difference value becomes larger than the predetermined first difference value, the operation controlling section 110 changes the template to be executed to the template that stops the connected device 410-1 with the greatest energy consumption, and when the difference value becomes larger than the second difference value that is larger than the first difference value, the operation controlling section 110 changes the template to be executed to the template that stops the connected device 410-2 with the second greatest energy consumption next to the connected device 410-1.

The template storing section 112 may store the air conditioning prioritized template for prioritizing use of the air conditioning device 412, and the lighting prioritized template for prioritizing use of the lighting device 414. The operation controlling section 110 may determine which of the air conditioning prioritized template and the lighting prioritized template to be selected according to the clock time.

For example, the operation controlling section 110 selects the air conditioning prioritized template from 1 pm to 4 pm. When it becomes dark after 5 pm, the operation controlling section 110 selects the lighting prioritized template.

After a predetermined time has passed from reselecting the template to be executed in order to reduce the energy consumption in the first compartment 400-1 that is selected based on the compartment type, the operation controlling section 110 may return the template to be executed to the first template to be executed before the change, and may reselect the template to be executed so that the energy consumption in the second compartment 400-2 is reduced. For example, after a predetermined time that corresponds to a discomfort level in the compartments 400-1 and 400-2 passes, the operation controlling section 110 reselects the template to be executed. When the difference between the discomfort level in the compartment 400-1 and that in the compartment 400-2 becomes larger than a predetermined value, the operation controlling section 110 may reselect the template to be executed so that the difference of the discomfort levels is reduced. By the above-mentioned control, the energy-saving apparatus 100 can equalize the environments of the plurality of the compartments 400.

The operation controlling section 110 may acquire information that shows at least one of temperature, humidity, luminance, and a status of detecting a person in the compartment 400, and may reselect the template to be executed further according to the acquired information. For example, when the difference value is larger than a predetermined value, the operation controlling section 110 changes the template to be a template for reducing the energy consumption in the compartment 400 where no person is detected. When the difference value is larger than a predetermined value, the operation controlling section 110 may change the template to be a template for reducing the energy consumption in the compartment 400 where the temperature, the humidity, or the luminance are within a predetermined range. Owing to such controls, the energy-saving apparatus 100 can make the energy consumption close to the target value, and can also maintain a good environment.

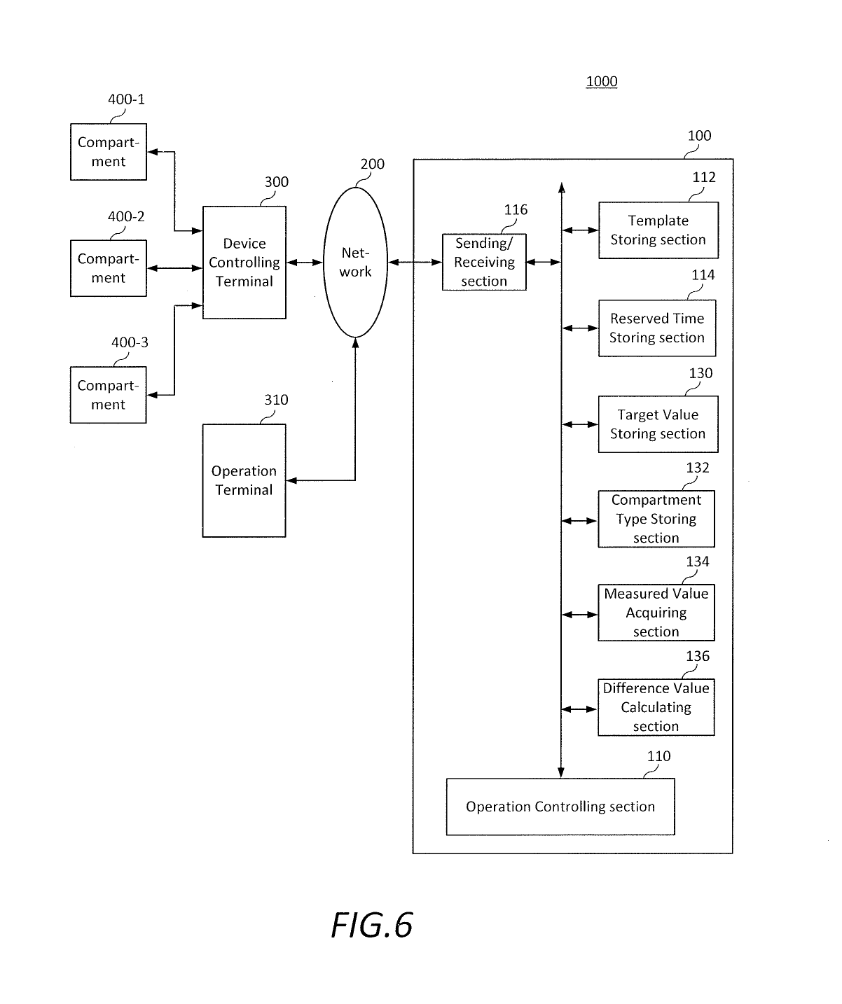

FIG. 6 shows an exemplary configuration of the energy-saving apparatus 100 and the energy-saving system 1000 according to another embodiment. The energy-saving apparatus 100 shown in FIG. 6 further comprises a reserved time storing section 114 relative to the energy-saving apparatus 100 shown in FIG. 5. The reserved time storing section 114 shown in FIG. 6 has the same function as the reserved time storing section 114 shown in FIG. 1, and stores the information including the reserved time of each compartment 400.

The operation controlling section 110 selects the template to be executed further according to the reserved time that the reserved time storing section 114 stores. For example, assume that the compartment 400-1 is reserved from 3 p.m., and the compartment 400-2 is not reserved. In this case, when the difference value is larger than 0 kW, a predetermined first difference value, the operation controlling section 110 may reselect the template to be executed so that the energy consumption in the non-reserved compartment 400-2 is reduced according to the reserved time of 3 p.m.

When the difference value is larger than the second difference value, which is larger than the first difference value, the operation controlling section 110 may further reselect the template to be executed so that the energy consumption in the reserved compartment 400 is reduced. For example, when the difference value is larger than 2 kW during the reserved time of the compartment 400-1, the operation controlling section 110 changes the template for reducing the energy consumption in the compartment 400-2 with a lower power-saving priority as well so that the difference from the target value is prevented from increasing.

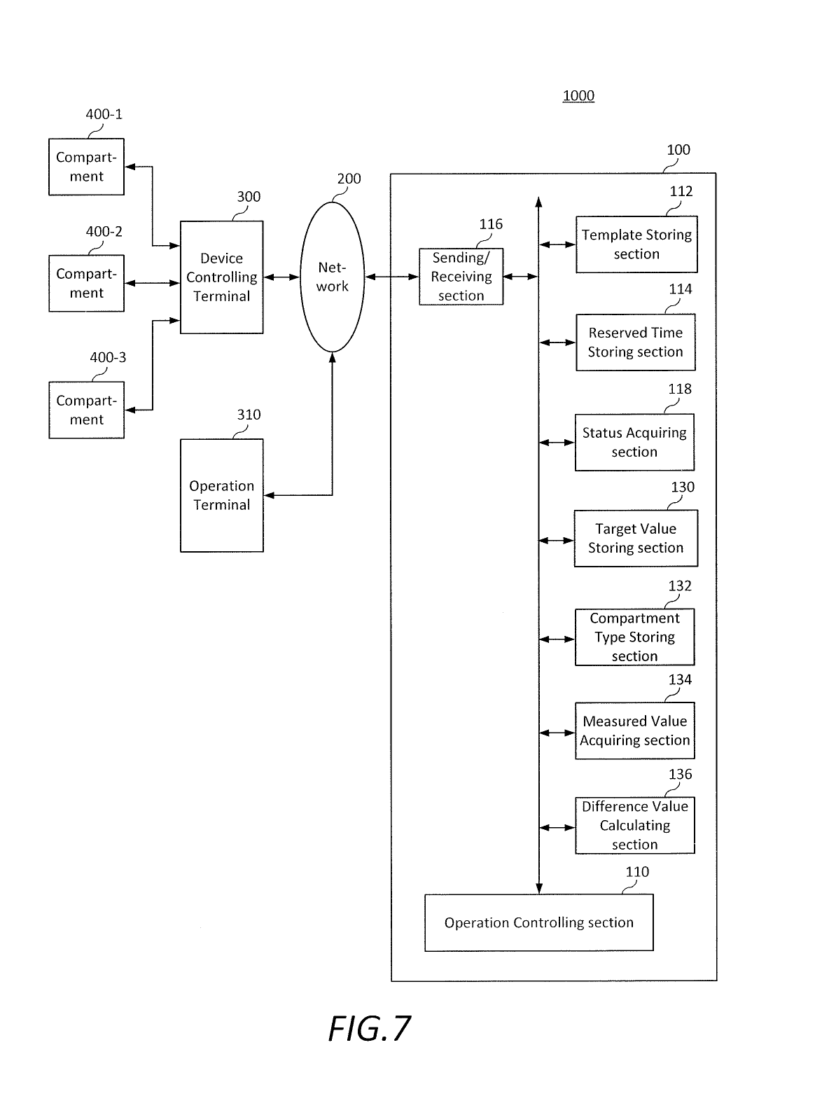

FIG. 7 shows an exemplary configuration of the energy-saving apparatus 100 and the energy-saving system 1000 according to another embodiment. The energy-saving apparatus 100 shown in FIG. 7 further comprises a status acquiring section 118, as compared to the energy-saving apparatus 100. The status acquiring section 118 shown in FIG. 4 has the same function as the status acquiring section 118 shown in FIG. 4, and acquires a person detection signal that shows a detection of a person in each compartment 400.

When the difference value is larger than the predetermined first difference value, the operation controlling section 110 reselects the template to be executed in order to reduce the energy consumption in the compartment 400 where no person is detected, as shown by a non-active person detection signal, from among the reserved compartments 400. When the difference value is larger than the second difference value, which is larger than the first difference value, the operation controlling section 110 reselects the template to be executed so that the energy consumption in the compartment 400 with an active person detection signal is further reduced.

When the person detection signal is non-active after a predetermined time has passed from the start of the reserved time of the reserved compartment 400, the operation controlling section 110 may reselect the template to be executed so that the energy consumption in the reserved compartment 400 is reduced. The operation controlling section 110 may determine the duration of time before reselecting the template according to the amount of the difference value when no person comes after the start of the reserved time. For example, when the difference value is larger than the first difference value and the requirement for reducing the energy consumption is large, the operation controlling section 110 may set the time until the template is selected to be a first time, and when the difference value is less than the first difference value, the operation controlling section 110 may reselect the template after passing of the second time that is longer than the first time.

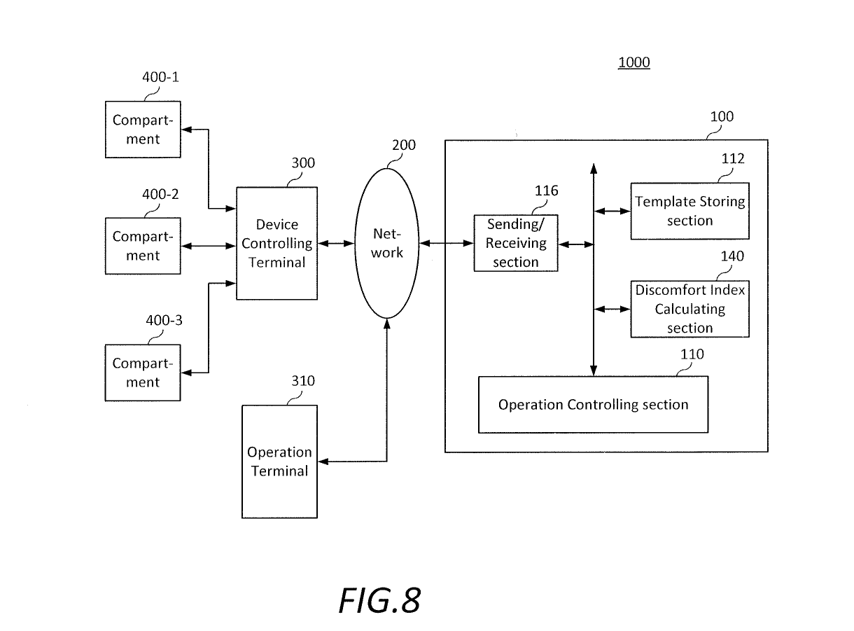

FIG. 8 shows an exemplary configuration of the energy-saving apparatus 100 and the energy-saving system 1000 according to another embodiment. The energy-saving apparatus 100 shown in FIG. 8 comprises a discomfort index calculating section 140, in place of the reserved time storing section 114 in the energy-saving apparatus 100 shown in FIG. 1. The discomfort index calculating section 140 calculates a discomfort index that shows a discomfort level of a user of the connected device 410 corresponding to the template to be executed based on an amount of change of a setting of the connected device 410. The discomfort index is one of the statuses of the compartment in which the connected devices 410 are located. The discomfort index calculating section 140 may preliminarily store an initial value of the discomfort index of each compartment 400 in association with each template.

Specifically, the discomfort index calculating section 140 acquires operating information for changing settings in the connected device 410 in each compartment 400 through the device operation terminal 300 and the network 200. The discomfort index calculating section 140, for example, acquires information in response to operations for changing temperature of the air conditioning device 412. The discomfort index calculating section 140 may acquire information corresponding to the set temperature.

In one instance, the discomfort index calculating section 140 calculates the discomfort index based on the number of times that the key for changing the setting of the connected device 410 is pushed. The discomfort index calculating section 140 may calculate the discomfort index based on the amount of change of the set temperature of the connected device 410.

Specifically, for example, when a predetermined number of operations of changing the setting of the connected device 410 is conducted, the discomfort index calculating section 140 increases the numerical value of the discomfort index by 1. In the same manner, the discomfort index calculating section 140 may increase the discomfort index by 1 each time the set temperature is changed by n degrees Celsius, where n is a natural number.

The discomfort index calculating section 140 may store the calculated discomfort index in association with the template in use. The discomfort index calculating section 140 may further store the discomfort index in association with the compartment 400. By storing the templates in association with the discomfort index using the discomfort index calculating section 140, the energy-saving apparatus 100 and the energy-saving system 1000 can save energy while reducing the discomfort level of the user because the energy-saving apparatus 100 and the energy-saving system 1000 can improve the discomfort index.

The operation controlling section 110 reselects the template to be executed according to the discomfort index. For example, when the discomfort index changes, the operation controlling section 110 changes the template to be executed to the template that can reduce the discomfort index. Specifically, after the discomfort index calculating section 140 stores templates in association with the changed discomfort index, the operation controlling section 110 searches the templates that are stored in association with the discomfort index values, and reselects the template that corresponds to the smaller discomfort index. More specifically, when the discomfort index increases due to an operation of lowering the temperature of the air conditioning device 412 that is operating a cooling function in the “hard energy-saving mode,” the operation controlling section 110 may change the template to be executed to the template for operating the cooling function of the air conditioning device 412 in the “soft energy-saving mode,” in which energy consumption is larger than that of the “hard energy-saving mode.”

When the discomfort index becomes a predetermined value that corresponds to the amount of change of the setting of the connected device 410, the operation controlling section 110 may reselect the template to be executed so that a larger amount of energy is consumed. For example, the operation controlling section 110 does not change the template when the discomfort index increases only by 1, but the operation controlling section 110 does change the template when the discomfort index increases by 2.

The discomfort index calculating section 140 does not change the discomfort index when the change of the setting is canceled within a predetermined time after the change of the setting is made. The operation controlling section 110 does not reselect the template to be executed when an operation for canceling the previous change of the setting is conducted within a predetermined time after the setting was changed.

For example, the discomfort index calculating section 140 does not change the discomfort index if the setting is changed to increase the temperature within a first time (for example, 10 seconds) after an operation of changing the setting for decreasing the temperature so that the discomfort index is prevented from being changed by an erroneous operation of changing the setting. In order to calculate the discomfort index based on a user's discomfort in a stable room environment, the discomfort index calculating section 140 may not change the discomfort index when the setting is changed to increase the temperature within a second time (for example, 5 minutes) that is longer than the first time.

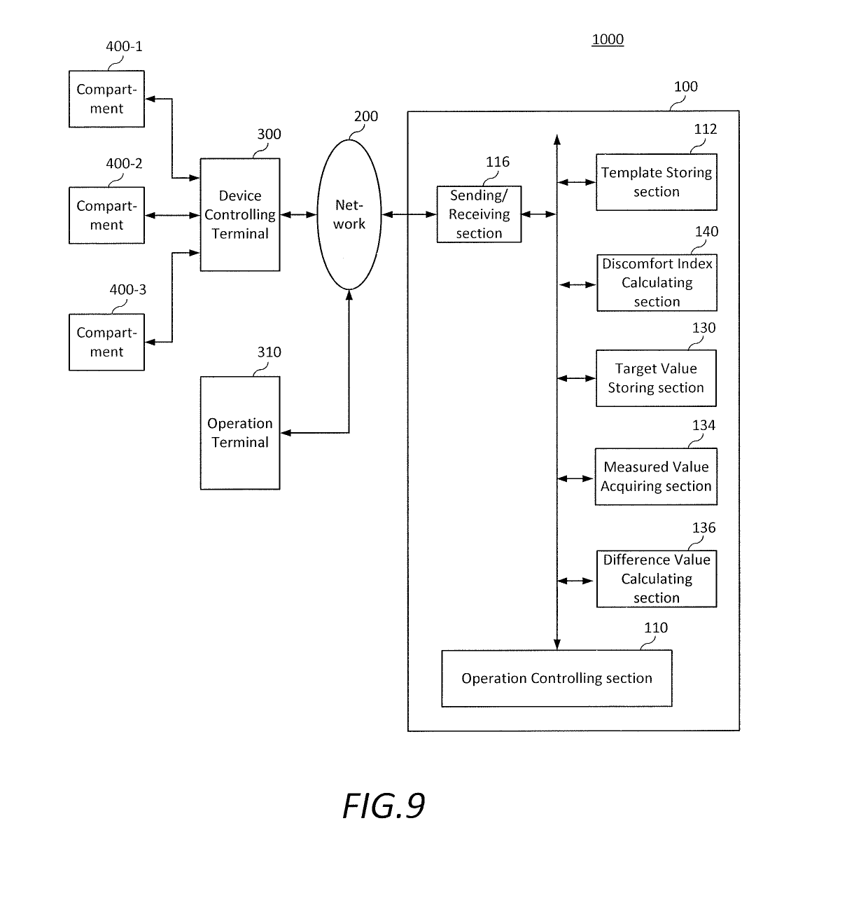

FIG. 9 shows an exemplary configuration of the energy-saving apparatus 100 and the energy-saving system 1000 according to another embodiment. The energy-saving apparatus 100 in FIG. 9 further comprises a target value storing section 130, a measured value acquiring section 134, and a difference value calculating section 136, as compared to the energy-saving apparatus 100 shown in FIG. 8. The energy-saving apparatus 100 may further comprise the compartment type storing section 132. The target value storing section 130, the measured value acquiring section 134, and the difference value calculating section 136 have the same functions as the target value storing section 130, the measured value acquiring section 134, and the difference value calculating section 136 shown in FIG. 5.

The operation controlling section 110 determines whether or not to reselect the template to be executed in response to the variation of the discomfort index based on the difference value calculated by the difference value calculating section 136. For example, when the difference value is larger than the first difference value, the operation controlling section 110 does not change the template even if the discomfort index becomes larger, in order to prevent from increasing the energy consumption. When the difference value is smaller than the second difference value, which is smaller than the first difference value, the operation controlling section 110 determines that there is a margin for increasing the energy consumption, and changes the template so that the discomfort index is decreased when the discomfort index increases.

When the difference value is larger than a predetermined amount, and a predetermined time has passed from reselecting the template to be executed in response to the variation of the discomfort index, the operation controlling section 110 may reselect the template to be executed that was used before changing the template. For example, the operation controlling section 110 returns to the previous template after the time needed for the room environment to become stable has passed from when the template was changed in response to the variation of the discomfort index.

The discomfort index calculating section 140 may decrease the discomfort index if the setting of the connected device 410 is not changed within a predetermined time after the room environment becomes stable with the previous template being used. Owing to the above-mentioned manner, the energy-saving apparatus 100 can reduce the energy consumption, and can also decrease the discomfort level since the discomfort index calculating section 140 can calculate the discomfort index in a stable room environment.

The operation controlling section 110 may reselect the template to be executed when the setting is changed to increase the energy consumption of the connected device 410, and when the difference value is smaller than a predetermined value. Specifically, when the difference value is larger than the predetermined value, the operation controlling section 110 does not reselect the template to be executed irrespective of the amount of the discomfort index, and when the difference value is smaller than the predetermined value, the operation controlling section 110 reselects the template to be executed according to the discomfort index.

In one instance, when the difference value is larger than the target value, the operation controlling section 110 judges that increasing the energy consumption is undesirable, and does not change to the template that increases the energy consumption. On the other hand, when the difference value is less than the target value, the operation controlling section 110 judges that decreasing the discomfort by increasing the energy consumption is preferable, and changes to the template that decreases the discomfort level.

The discomfort level of a user is affected by the temperature, the humidity, and the luminance of the compartment 400 in which the connected devices 410 are located. For example, if the operation controlling section 110 selects the template indicating that the user feels comfortable when the outside air temperature is 25 degrees Celsius, the user feels uncomfortable when the outside air temperature is 30 degrees Celsius. Therefore, the discomfort index calculating section 140 may calculate the discomfort index in association with the environmental conditions of the place where the connected device 410 operates. For example, the discomfort index calculating section 140 calculates the discomfort index in association with at least one of the ambient temperature, the humidity, and the luminance of the compartment 400 in which the connected device 410 is located.

The operation controlling section 110 may acquire the environmental conditions of the compartment 400, and may select the template to be executed based on the discomfort index that corresponds to the acquired environmental conditions. For example, when the outside air temperature of the compartment 400 in which the connected device 410 is located is 30 degrees Celsius, the operation controlling section 110 selects the template according to the discomfort index corresponding to the aforesaid outside temperature.

In one instance, the operation controlling section 110 selects the template associated with the discomfort index corresponding to the condition that the user begins to feel uncomfortable. Owing to such an operation, the operation controlling section 110 can reduce the energy consumption without making the user more comfortable than required.

When the difference value is larger than the predetermined first difference value, the operation controlling section 110 increases the energy consumption in the compartment 400-1 in which discomfort level is relatively high from among a plurality of the compartments 400, and when the difference value is smaller than the first difference value, the operation controlling section 110 may increase the energy consumption in the compartment 400-2 in which discomfort level is smaller than that of the compartment 400-1 from among a plurality of the compartments 400. Owing to such controls, the energy-saving apparatus 100 can equalize the discomfort level in a plurality of the compartments, and also can reduce the energy consumption.

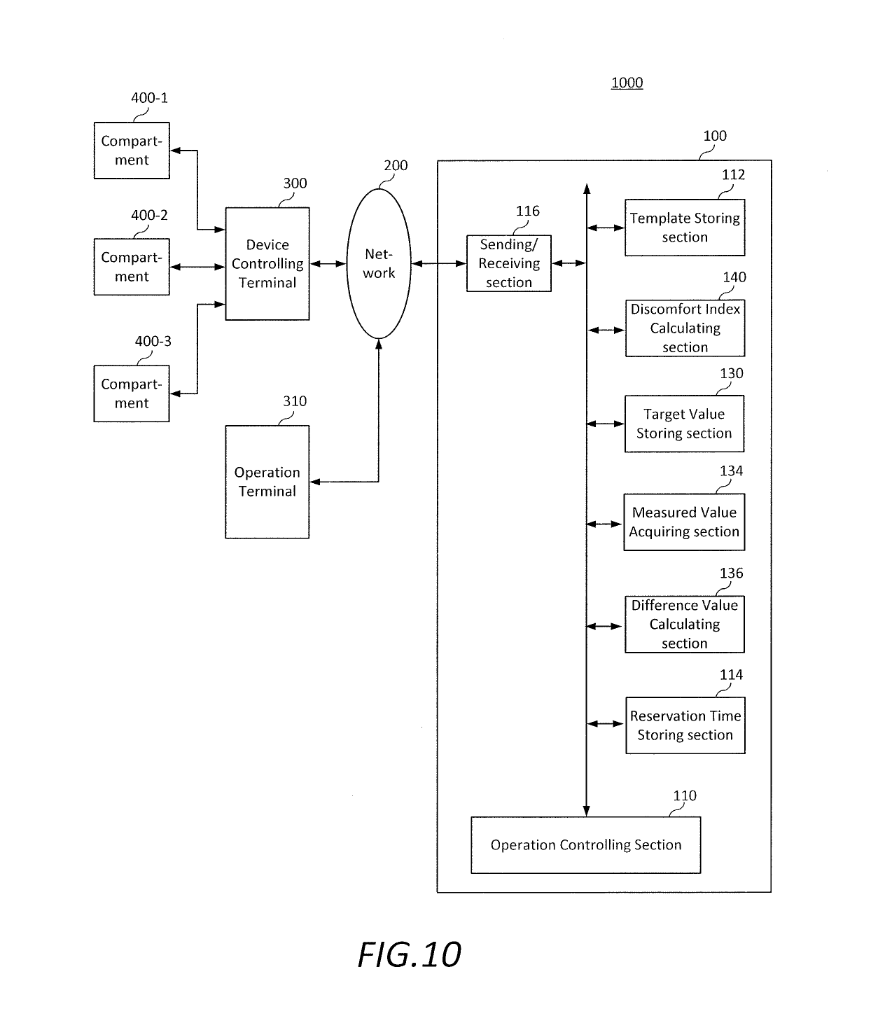

FIG. 10 shows an exemplary configuration of the energy-saving apparatus 100 and the energy-saving system 1000 according to another embodiment. The energy-saving apparatus 100 shown in FIG. 10 further comprises the reserved time storing section 114, as compared to the energy-saving apparatus 100 shown in FIG. 9. The operation controlling section 110 may select the template according to the reserved time that the reserved time storing section 114 stores and a discomfort index that is calculated by the discomfort index calculating section 140. The operation controlling section 110 may select the template according to at least one of the reserved time, the discomfort index, and the difference value.

The operation controlling section 110 may determine whether or not to reselect the template to be executed according to (i) the energy consumption when the template selected based on the reserved time is used, and (ii) the discomfort index corresponding to the aforementioned template. Specifically, if the difference between (i) the energy consumption of using the first template and (ii) the energy consumption of using the second template that is used during non-reserved time and that corresponds to a larger discomfort index than the first template is smaller than a predetermined amount, the operation controlling section 110 does not change to the second template even if the reserved time finishes.

If the difference value is larger than the first difference value, the operation controlling section 110 may change the template irrespective of the discomfort index when the reserved time finishes, and if the difference value is less than the first difference value, the operation controlling section 110 may change to the template that corresponds to a predetermined range of the discomfort index.

When the discomfort index corresponding to the second template is smaller than the first template in use, and when the increased amount of the energy consumption compared to that of the first template is smaller than a predetermined value, the operation controlling section 110 may change to the second template that decreases the discomfort index. The operation controlling section 110 may change to the second template when the difference value is smaller than the predetermined value.

The discomfort index calculating section 140 may calculate an air conditioning discomfort index showing a discomfort level of a user regarding temperature based on an amount of change of the setting of the air conditioning device 412, and may calculate a lighting discomfort index showing a discomfort level of a user regarding luminance based on an amount of change of the setting of the air conditioning device 414. The operation controlling section 110 may change the template to be executed to either one of the air conditioning prioritized template and the lighting prioritized template based on the amount of the air conditioning discomfort index and the lighting discomfort index.

For example, the operation controlling section 110 selects the template for decreasing the discomfort index with a larger value from among the air conditioning discomfort index and the lighting discomfort index. The operation controlling section 110 may select either one of the air conditioning prioritized template and the lighting prioritized template, further according to the predetermined priority between the air conditioning device 412 and the lighting device 414.

When the difference value is smaller than a predetermined value, and when the air conditioning discomfort index is larger than the lighting discomfort index, the operation controlling section 110 may change the template to be executed to the air conditioning prioritized template, and when the lighting discomfort index is larger than the air conditioning discomfort index, the operation controlling section 110 may change the template to be executed to the lighting prioritized template.

The template storing section 112 may store a plurality of the templates in association with each compartment 400. The discomfort index calculating section 140 calculates the discomfort index in association with each of the compartments 400. The operation controlling section 110 may change the template so that the discomfort level of the compartments 400 with a larger discomfort index is decreased.

The operation controlling section 110 may further change the template to be executed based on the difference value. For example, if the difference value is negative, the operation controlling section 110 changes the template to be executed so that the discomfort levels of all the compartments are decreased irrespective of the discomfort index. When the difference value is positive, the operation controlling section 110 changes the template to be executed so that only the discomfort levels of the compartments 400 with the discomfort index larger than a predetermined value are reduced. The operation controlling section 110 may select the compartment 400 for which the discomfort level is to be decreased based on the amount of the difference value, and may select the template based on the aforesaid selection.

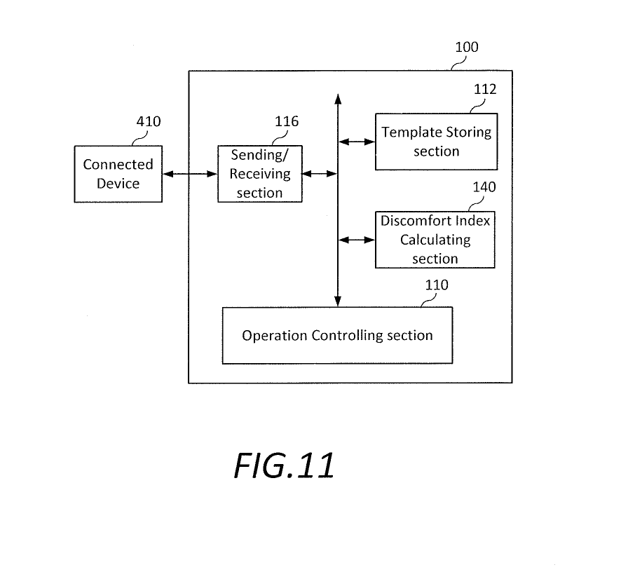

FIG. 11 shows an exemplary configuration of the energy-saving apparatus 100 according to another embodiment. The energy-saving apparatus 100 shown in FIG. 11 has the same functions as the energy-saving apparatus 100 shown in FIG. 8, but is directly connected with the connected apparatuses 410. As shown in FIG. 11, the energy-saving apparatus 100 may directly control a connected apparatus 410 without passing through the device controlling terminal 300.

The energy-saving apparatus 100 may be combined with the connected apparatuses 410. For example, the energy-saving apparatus 100 is an air conditioning apparatus or a lighting apparatus whose operation is controlled according to the discomfort index that is calculated based on the amount of the operation for changing the setting.

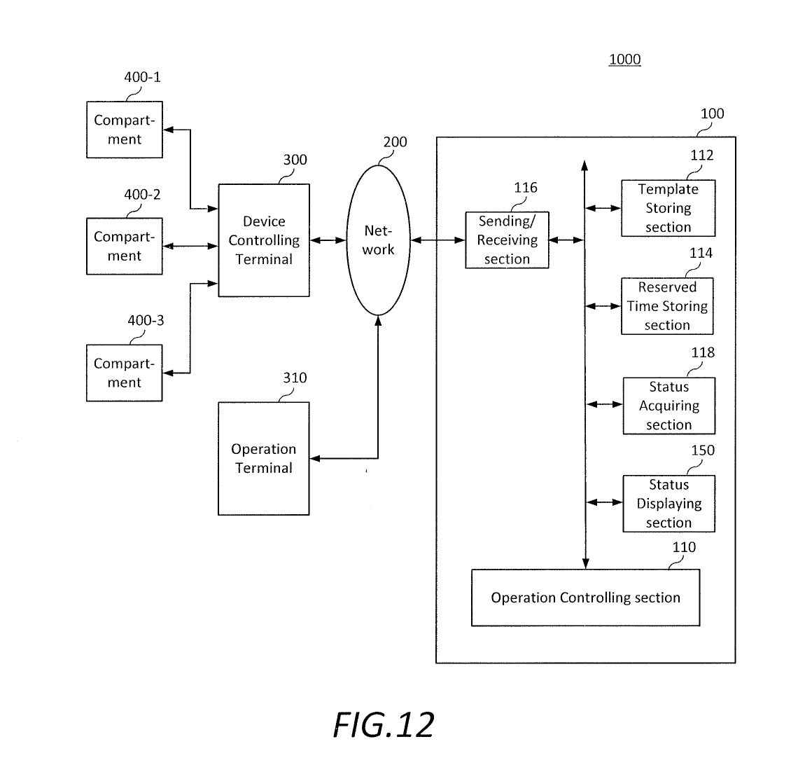

FIG. 12 shows an exemplary configuration of the energy-saving apparatus 100 and the energy-saving system 1000 according to another embodiment. The energy-saving apparatus 100 shown in FIG. 12 is different from the energy-saving apparatus 100 shown in FIG. 4 in that the energy-saving apparatus 100 comprises a status displaying section 150.

The status displaying section 150 displays a status of the connected apparatus 410 in the operation terminal 310. For example, when the status acquiring section 118 receives a compartment status signal showing that a person is present from the sensor 416-1 which is installed in the reserved compartment 400-1, the status displaying section 150 displays the status of the compartment 400-1 as “using” on the operation terminal 310. When the status acquiring section 118 receives the compartment status signal showing that a person is present from the sensor 416-2 which is installed in the non-reserved compartment 400-2, the status displaying section 150 displays the status of the compartment 400-2 as “unauthorized use” on the operation terminal 310.

The status displaying section 150 may displays the status as “not in use” when no person is detected despite the compartment being reserved. When the air conditioning apparatus 412 or the lighting apparatus 414 has been turned on despite no person being detected, the status displaying section 150 causes the operation terminal 310 to display a warning that the compartment is “not in use.” Thus, since the user of the energy-saving apparatus is able to figure out the status of the compartment 400 in real time as a result of the status displaying section 150 displaying the status of the compartment 400 on the operation terminal 310 based on the reservation information and the compartment status signal, the user is motivated to act for energy-saving.

The operation controlling section 110 may select the templates in conjunction with the contents that the status displaying section 150 displays on the operation terminal 310. For example, after a predetermined time has passed from displaying “unauthorized use” on the operation terminal 310, the operation controlling section 110 selects the template in which energy consumption is smaller than the template selected when the status displaying section 150 displays “using”. The operation controlling section 110 may reduce the energy consumption in the compartment 400 by reselecting the template to be executed after a predetermined time has passed after the status displaying section 150 displayed “not in use” on the operation terminal 310.

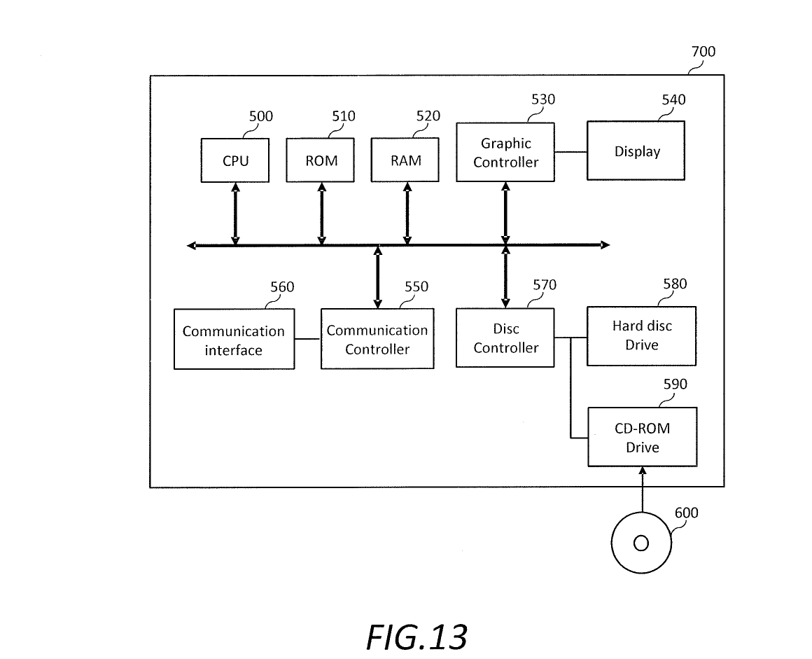

FIG. 13 shows an exemplary hardware configuration of a computer 700 that composes the energy-saving apparatus 100 according to another embodiment. The computer 700 has a CPU500, a ROM 510, a RAM 520, a graphic controller 530, a display 540, a communication interface 560, a communication controller 570, a hard disc drive 580, and a CD-ROM drive 590. In the computer 700, the CPU 500 reads the program that is stored in the ROM 510, and functions as the energy-saving apparatus 100 by executing the program.

The CPU 500 may function as the energy-saving apparatus 100, by reading the program that is stored in the hard disc drive 580 through the disc controller 570 and by executing the program. The CPU 500 may function as the energy-saving apparatus 100 by reading the program that is stored in the recording medium 600 and executing it. The CPU 500 may function as the energy-saving apparatus 100 by executing the program that is downloaded from a server through the network.

The program to be executed by the CPU 500 is an energy-saving program for controlling the operation of the connected devices 410 to reduce the energy consumption. For example, the computer 700 functions as the energy-saving apparatus 100 as a result of the CPU 500 executing the energy-saving program.

Specifically, the CPU 500 functions as the operation controlling section 110, the status acquiring section 118, the measure value acquiring section 134, the difference value calculating section 136, and the discomfort index calculating section 140 by executing the program. The ROM 510 or the RAM 520 functions as the template storing section 112, the reservation time storing section 114, the target value storing section 130, and the compartment type storing section 132.

The CPU 500 acquires the information that shows the status of the connected devices 410 from the device controlling terminal 300, or acquires the information that shows the reservation of the compartments 400 inputted on the operation terminal 310, through the communication controller 550 and the communication interface 560, which function as the sending/receiving section 116. For example, the communication interface 560 is connected to the network 200 as typified by the internet, and the CPU 500 acquires the information sent from the device controlling terminal 300 and the operation terminal 310 that are connected with the network 200.

The CPU 500 displays at least one of the target value that is stored in the compartment type storing section 132, the measured value that is acquired by the measure value acquiring section 134, the difference value that is calculated by the difference value calculating section 136, or the operation terminal 310 that is connected through the communication controller 550 and the communication interface 560.

In one instance, when the computer 700 communicates with external computers, the CPU 500 executes the communication program that is loaded on the RAM 520, and gives the communication controller 550 an instruction to execute the communication processing according to the processing content that is described in the communication program. The communication controller 550 sends the data that is stored in the RAM 520 to the network 200 based on the control of the CPU 500.

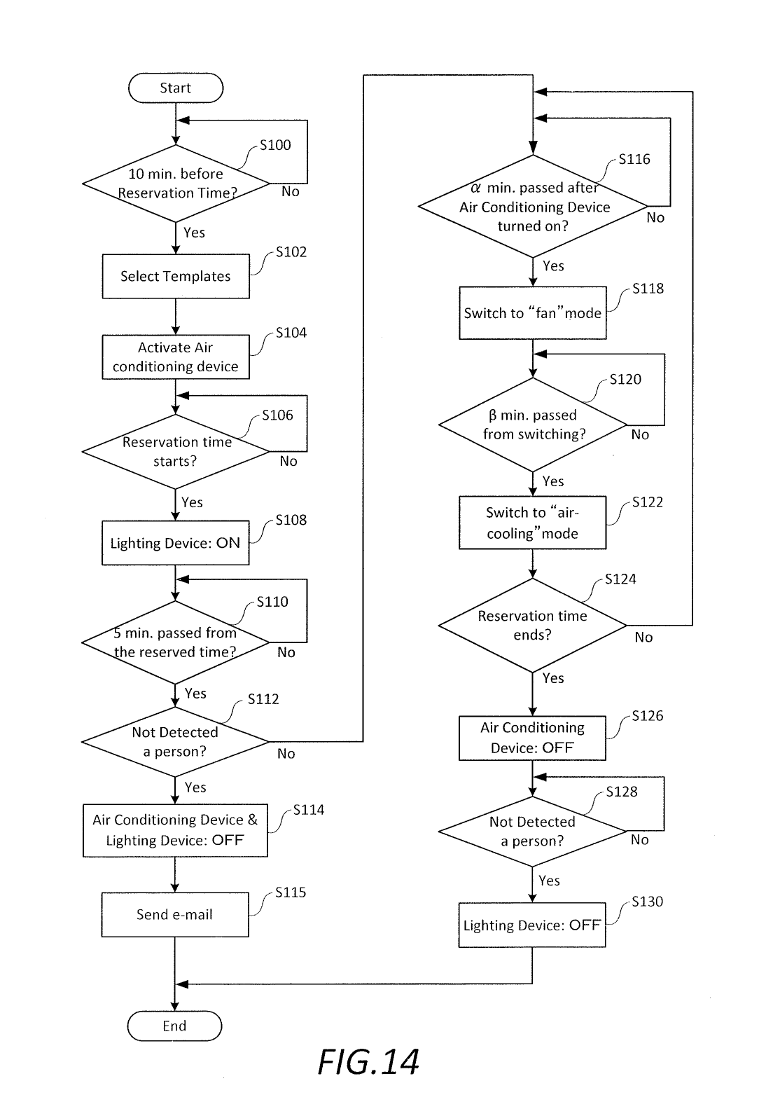

FIG. 14 shows an example of a flowchart when the CPU executes the energy-saving program according to the present embodiment. Specifically, FIG. 14 shows the operation by the energy-saving program when the compartment 400 shown in FIG. 1 is reserved.

The CPU 500, which functions as the operation controlling section 110, reads the starting time of the reservation of the compartment 400 from the reservation time storing section 114. When it becomes ten minutes before the reservation time (S100), the CPU 500 selects the template corresponding to the reservation contents from the template storing section 112 (S102). Henceforth, the CPU 500 operates in accordance with the selected template.

The CPU 500 activates the air conditioning apparatus 412 and operates it in an “air-cooling” mode (S104). When the reservation time comes (S106), the CPU 500 has the lighting apparatus 414 turn on (S108). After five minutes pass from the reservation time (S110), if the signal indicating detection of a person is not acquired from the status acquiring section 118 (S112), the CPU 500 has the air conditioning apparatus 412 and the lighting apparatus 414 turn off, and sends an e-mail to the predetermined address (S115).

When the CPU 500 acquires the signal indicating detection of a person from the status acquiring section 118 after five minutes have passed from the reservation time (S110), the CPU 500 continues to operate the air conditioning apparatus 412 and the lighting apparatus 414.

When α minutes have passed from activating the air conditioning apparatus 412 and starting the operation in the “air-cooling” mode (S116), the CPU 500 has the air conditioning apparatus 412 switch to a “fan” mode (S118). When β minutes pass from switching to the “fan” mode (S120), the CPU 500 operates the air conditioning apparatus 412 in “air-cooling” mode again (S122). Here, α and β are the values that are different from each other according to the templates that the CPU 500 selected. In the mode of suppressing energy consumption, β is larger and α is smaller than in the mode that does not suppress the energy consumption.

During the time prior to the end of the reservation time (S124), the CPU 500 repeats the operations from S116 to S122. When the reservation time ends, the CPU 500 stops the operation of the air conditioning apparatus 412 (S126). When the lighting apparatus 414 is turned on even though the CPU 500 does not acquire a signal indicating detection of a person from the status acquiring section 118 at the end of the reservation time (S128), the CPU 500 turns off the lighting apparatus 414 (S 130).

The CPU 500 may change the templates in accordance with the difference value in S116 to S122. In one instance, the CPU 500 changes the value of α and β based on the difference values. Specifically, when the difference value is larger than the target value, the CPU 500 may decrease α and increase β. When the difference value is smaller than the target value, the CPU 500 may increase α and decrease β.

The CPU 500 may change the template according to the discomfort index in S116 to S122. For example, when the discomfort index becomes larger than a predetermined value, the CPU 500 may increase α and decrease β. The CPU 500 may change the templates according to any of the reservation time, the difference value, and the discomfort index. In the same manner, it is apparent for a person skilled in the art that the CPU 500 can conduct all the embodiments described in the present description by executing the energy-saving program.

As described above, according to the energy-saving apparatus 100, the energy-saving system 1000, and the energy-saving program in this embodiment, the energy consumption can be suppressed because the room temperature of each compartment among the plurality of different compartments can be controlled one by one according to the reserved time of each compartment.

As described above, the present invention was explained by using embodiments of the invention. The technical scope of the present invention is not limited to the range of the above-mentioned embodiment. Adding various changes or adding, refinements to the above-mentioned embodiment are well known to those skilled in the art. It is apparent from the description of the claims that embodiments with being added such a change or a refinement can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not mean that the process must be performed in this order.

What is claimed is:

1. An energy-saving apparatus for controlling energy consumption of a connected device in a building, comprising:
a template storing section that stores a plurality of templates containing procedures for controlling the connected device;
an operation controlling section that selects a template to be executed that is used for controlling the operation of the connected device from among a plurality of the templates and controls the operation of the connected device according to the template to be executed; and
a discomfort index calculating section that calculates a discomfort index showing a discomfort level of a user of the connected device corresponding to the template to be executed, based on an amount of change of a setting of the connected device, and that stores the discomfort index in association with the template to be executed; wherein
the operation controlling section reselects the template to be executed based on the discomfort index.

2. The energy-saving apparatus according to claim 1, wherein
the operation controlling section reselects the template to be executed that was selected before the reselection when a predetermined time has passed from the reselection of the template to be executed based on the discomfort index, and
the discomfort index calculating section makes the discomfort index smaller when the setting of the connected device is not changed within a predetermined time after the room environment has become stable by using the reselected template to be executed selected before the reselection.

3. The energy-saving apparatus according to claim 1, wherein
the discomfort calculating section does not store the discomfort index when the change of the setting is canceled within a predetermined time after the change of the setting.

4. The energy-saving apparatus according to claim 1, wherein
the discomfort calculating section calculates the discomfort index showing a discomfort level of a user of the connected device in association with an environmental condition of a compartment where the connected device operates, and
the operation controlling section acquires the environmental condition of the compartment, and reselects the template to be executed stored by the discomfort index calculating section based on the discomfort index corresponding to the acquired environmental condition.

5. The energy-saving apparatus according to claim 1, wherein
the connected device is either a lighting device or an air conditioning device;
the template storing section stores an air conditioning prioritized template for reducing energy consumption of the lighting device and a lighting prioritized template for reducing energy consumption of the air conditioning device;
the discomfort index calculating section calculates an air conditioning discomfort index showing a discomfort level of a user regarding temperature based on an amount of change of the setting of the air conditioning device;
the discomfort index calculating section calculates a lighting discomfort index showing a discomfort level of a user regarding luminance based on an amount of change of the setting of the lighting device; and
the operation controlling section changes the template to be executed to either the air conditioning prioritized template or the lighting prioritized template based on the amount of the air conditioning discomfort index and the lighting discomfort index.

6. An energy-saving apparatus for controlling energy consumption of a connected device in each of a plurality of compartments in a building, comprising:
a template storing section that stores a plurality of templates containing procedures for controlling the connected device in each compartment;
a reserved time storing section that stores reserved times of each of the compartments; and
an operation controlling section that selects a template to be executed that is used for controlling the operation of the connected device from among a plurality of the templates, based on the reserved times, and controls the operation of the connected device in each of the compartments according to the selected template to be executed; wherein
the operation controlling section selects a first template to be executed when the compartment is not reserved, and selects a second template that is different from the first template when the compartment is reserved.

7. The energy-saving apparatus according to claim 6, further comprising:
a status acquiring section that acquires a presence status signal showing a presence of a person in the compartment, wherein
the operation controlling section selects the first template to be executed during a non-reserved time of the compartment, and selects the second template to be executed in which energy consumption in operating the connected device is greater than in the first template to be executed when the presence status signal shows that no one is present in the compartment during a reserved time of the compartment.

8. The energy-saving apparatus according to claim 6, further comprising:
a status acquiring section that acquires a presence status signal showing a presence of a person in the compartment, wherein
the operation controlling section controls the operation of the connected device in the compartment, when the presence status signal shows a presence of a person in the compartment during a non-reserved time of the compartment, according to the template to be executed in which energy consumption is smaller than the template executed when the presence status signal shows a presence of a person in the compartment during a reserved time of the compartment.

9. The energy-saving apparatus according to claim 6, further comprising:
a status acquiring section that acquires a presence status signal showing a presence of a person in the compartment, wherein
the operation controlling section reselects the template to be executed after sending an e-mail to a predetermined address when the presence status signal does not change after a predetermined time has passed from a start time of the reservation of the compartment.

10. A method for controlling a connected device in a building, comprising:
selecting a template to be executed that is used for controlling the operation of the connected device from among a plurality of the templates containing procedures for controlling the connected device;
controlling the operation of the connected device according to the template to be executed;
calculating a discomfort index showing a discomfort level of a user of the connected device corresponding to the template to be executed based on an amount of change of a setting of the connected device;
storing the discomfort index in association with the template to be executed; and
reselecting the template to be executed based on the discomfort index.

11. The method for controlling a connected device according to claim 10, further comprising:
reselecting the template to be executed that was selected before the reselection when a predetermined time has passed from the reselection of the template to be executed, based on change in the discomfort index; and
changing the discomfort index to be smaller when the setting of the connected device is not changed within a predetermined time after the room environment becomes stable by using the reselected template to be executed selected before the reselection.

12. The method for controlling a connected device according to claim 10, wherein
the discomfort index is not stored when the change of the setting is canceled within a predetermined time after the change of the setting.

13. A method for controlling a connected device in each of a plurality of compartments in a building, comprising:
storing reserved times of each of the compartments;
selecting a template to be executed that is used for controlling the operation of the connected device from among a plurality of the templates, wherein a first template to be executed is selected when the compartment is not reserved, and a second template that is different from the first template is selected when the compartment is reserved; and
controlling the operation of the connected device according to the selected template to be executed.

14. The method for controlling a connected device according to claim 13, further comprising:
acquiring a presence status signal showing a presence of a person in the compartment;
selecting the first template to be executed during a non-reserved time of the compartment; and
selecting the second template to be executed in which energy consumption due to operating the connected device is larger than in the first template to be executed when the presence status signal shows that no one is present in the compartment during a reserved time of the compartment.

15. The method for controlling a connected device according to claim 13, further comprising:
acquiring a presence status signal showing a presence of a person in the compartment; and
controlling the operation of the connected device in the compartment, when the presence status signal shows a presence of a person in the compartment during a non-reserved time of the compartment, according to the template to be executed in which energy consumption is smaller than the template executed when the presence status signal shows a presence of a person in the compartment during a reserved time of the compartment.

16. The method for controlling a connected device according to claim 13, further comprising:
acquiring a presence status signal showing a presence of a person in the compartment, wherein
reselecting the template to be executed after sending an e-mail to a predetermined address when the presence status signal does not change after a predetermined time has passed from a start time of the reservation of the compartment.

17. An energy-saving system for controlling energy consumption of a connected device in a building, comprising:
a device controlling terminal that controls the connected device; and
a server that stores a plurality of templates containing procedures for making the device controlling terminal control the connected device; wherein the server includes
a template storing section that stores a plurality of templates containing procedures for controlling the connected device;
an operation controlling section that selects a template to be executed that is used for controlling the operation of the connected device from among a plurality of the templates and that makes the device controlling terminal control the operation of the connected device according to the template to be executed; and
a discomfort index calculating section that calculates a discomfort index showing a discomfort level of a user of the connected device corresponding to the template to be executed, based on an amount of change of a setting of the connected device, and that stores the discomfort index in association with the template to be executed; wherein
the operation controlling section reselects the template to be executed based on the discomfort index.

18. An energy-saving system for controlling energy consumption of a connected device in each of a plurality of compartments in a building, comprising:
a device controlling terminal that controls the connected device in each of the compartments; and
a server that stores a plurality of templates containing procedures for making the device controlling terminal control the connected device; wherein
the device controlling terminal controls the connected device in each of the compartments according to the template to be executed selected from among the plurality of templates by the server based on the reserved time of the compartment, and
the server selects a first template to be executed when the compartment is not reserved, and selects a second template that is different from the first template when the compartment is reserved.
